(19) United States
(12) Patent Application Publication
(10) Pub. No.: US 2015/0285126 A1
(43) Pub. Date: Oct. 8, 2015

(54) OIL CHANNEL FOR ENGINE

(71) Applicant: Caterpillar Energy Solutions GmbH, Mannheim (DE)

(72) Inventor: Karl STELLWAGEN, Frankenthal (DE)

(73) Assignee: Caterpillar Energy Solutions GmbH, Mannheim (DE)

(21) Appl. No.: 14/659,249

(22) Filed: Mar. 16, 2015

(30) Foreign Application Priority Data
Apr. 4, 2014 (EP) 14001237.8

(51) Int. Cl. F01P 3/08; F02B 75/20; F02F 1/14; F02F 11/00; F01P 11/04; F02F 1/00

(52) U.S. Cl. CPC F01P 3/08; F01P 11/04; F02F 1/004; F02F 1/14; F02F 11/005; F02B 75/20; F01P 2003/006

(57) ABSTRACT

An engine block is disclosed. The engine block may have a cylinder. The engine block may also have a piston that may slide within the cylinder. Further, the engine block may have a liner positioned between the cylinder and the piston. The engine block may also have a groove disposed circumferentially about the liner. The groove may be in communication with the liner and the cylinder. The engine block may have at least two oil nozzles arranged spaced apart from each other. The oil nozzles may be configured to spray oil on the piston. The engine block may also have an oil channel configured to supply oil to at least one of the two oil nozzles via the groove.

### TECHNICAL FIELD

The present disclosure relates to a cooling means for an engine, and more particularly, to an oil channel provided in association with the engine.

### BACKGROUND

An engine used for powering a machine, like an electric generator, generally includes a cooling system associated therewith. The cooling system is configured to maintain a temperature of various parts of the engine. The cooling system is configured to direct a coolant through various parts of the engine, for example, a piston of the engine. The piston may be cooled by spraying the coolant, for example oil, through an oil nozzle from below the piston. Engines including larger cylinder dimensions and high cylinder power generally produce more amount of heat. Accordingly, the piston of such engines is provided with two oil nozzles located on opposite sides of the piston. CL SUMMARY OF THE DISCLOSURE

In one aspect of the present disclosure, an engine block is disclosed. The engine block includes a cylinder and a piston. The piston is slidably received within the cylinder. The engine block also includes a liner. The liner is positioned between the cylinder and the piston. The engine block further includes a groove. The groove is provided about and in communication with the liner and the cylinder. The engine block includes at least two oil nozzles. The oil nozzles are arranged spaced apart from each other. The oil nozzles are configured to spray oil on the piston. The engine block also includes an oil channel. The oil channel is configured to supply oil to at least one of the at least two oil nozzles via the groove. The engine may comprise a single oil channel.

One of the oil nozzles is provided on a first side of the piston and another oil nozzle is provided on a second side of the piston, such that the first and second sides oppose each other.

The oil channel may be provided on the first side of the piston, and supply oil via the groove to the oil nozzle at the second side of the piston or vice versa. Providing the oil channel in association with each piston is inexpensive. Also, the oil channel provides a compact and a less complex design of the engine block. Further, the groove is provided in fluid communication with the oil nozzles. The groove may fluidly connect the oil nozzles provided in association with the piston to the oil channel. The engine block may include a set of grooves. In one embodiment, when the liner is relatively thick, the groove is provided on a lower part of the liner, such that a depth of the groove is lesser than a thickness of the liner. In another embodiment, wherein the liner is relatively thin, the groove is provided in the engine block. More particularly, the groove is provided in communication with an inner wall of the cylinder. A sealing member is provided in association with and surrounding the groove. The sealing member may be positioned within the liner or the engine block. The engine block may be utilized for an inline engine or a V-type engine. In the V-type engine, the oil channel may be positioned at a center of the V configuration. Alternatively, the oil channel may be provided on both outer sides of the V configuration respectively.

In another aspect of the present disclosure, a cylinder liner is provided. The cylinder liner includes an inner surface. The cylinder liner also includes an outer surface. Further, the cylinder liner includes a circumferential channel with at least an opening at the outer surface to transport oil.

The cylinder liner includes the inner and outer surface, such that the circumferential channel is a groove provided at the outer surface of the cylinder liner. The cylinder liner includes an upper part and a lower part. The upper part of the cylinder liner is directed in an operational state to a cylinder head. Further, the circumferential groove is provided at the lower part of the cylinder liner.

Other features and aspects of this disclosure will be apparent from the following description and the accompanying drawings.

### BRIEF DESCRIPTION OF THE DRAWINGS

FIG. 1 is a perspective view of an exemplary engine, according to one embodiment of the present disclosure; and

FIGS. 2 and 3 are cross sectional views of a portion of the engine of FIG. 1 showing an engine block and a piston of the engine, according to various embodiments of the present disclosure.

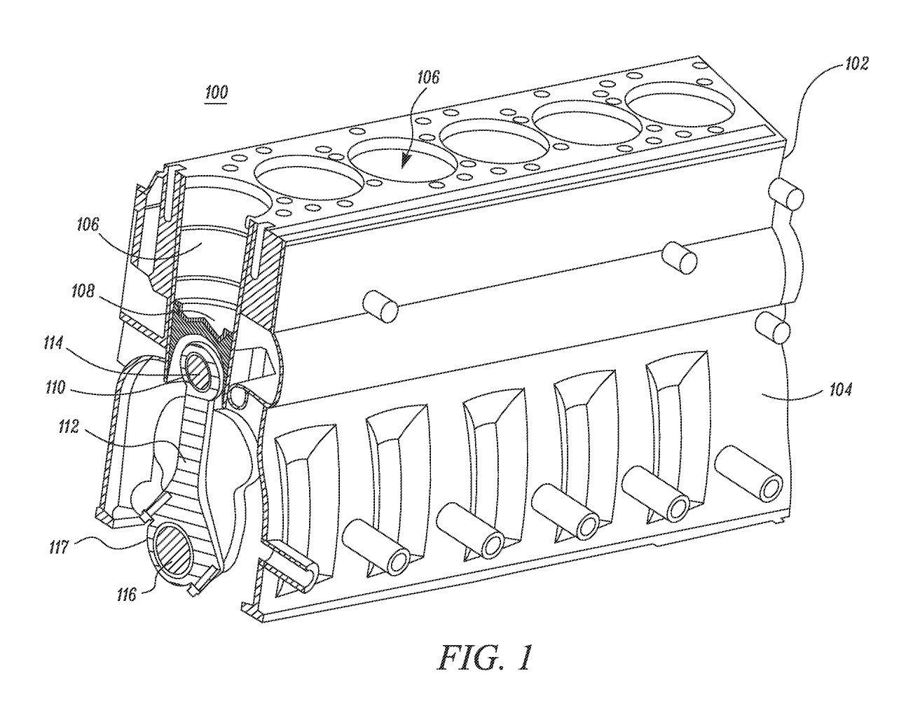

### DETAILED DESCRIPTION

Wherever possible, the same reference numbers will be used throughout the drawings to refer to the same or the like parts. Referring now to FIG. 1, an exemplary engine 100 is illustrated. More specifically, the engine 100 is a multi cylinder internal combustion (IC) engine. The engine 100 may be any of an inline engine or a V-type engine. In the illustrated embodiment, the engine 100 is embodied as the inline engine.

The engine 100 may be powered by any one or a combination of known liquid or gaseous fuels including, but not limited to, gasoline, diesel, natural gas, petroleum gas and bio-fuels. The engine 100 may be used to provide power to any machine including, but not limited to, an electric generator, an on-highway truck, an off-highway truck, an earth moving machine and so on. The engine 100 may include an engine housing 102. The engine housing 102 may include a cylinder head (not shown) and an engine block 104. The engine block 104 may include a plurality of cylinders 106.

Each of the plurality of the cylinders 106 is configured to house a piston 108. During operation of the engine 100, the piston 108 may have a translatory movement within the cylinder 106. The piston 108 may be coupled to an eye end 110 of a connecting rod 112 by a gudgeon pin 114. The connecting rod 112 is configured to convert the translatory movement of the piston 108 to a rotary movement of a crankshaft 116. A fork end 117 of the connecting rod 112 may be coupled to the crankshaft 116.

The crankshaft 116 of the engine 100 may be provided within a crankcase (not shown). The crankcase and the engine block 104 may be cast as a single unit. Alternatively, the crankcase may be cast as a separate part and later bolted to the engine block 104. The crankcase is provided below the plurality of cylinders 106. The crankcase may include a sump (not shown) provided therein. The sump may be configured to carry a lubricant, for example, oil. The lubricant is configured to lubricate various moving parts of the engine 100. In one embodiment, the sump may also serve as a collection unit for the oil transported through various parts of the engine 100.

A cooling system is provided for the engine 100. The cooling system is configured to maintain a temperature of various engine parts in order to avoid overheating of the engine parts. The cooling system may include various cooling channels provided within the engine 100. A coolant is configured to flow through the cooling channels. The coolant is configured to exchange heat with the engine parts. The coolant may be pumped into the cooling channels by a coolant pump (not shown) associated with the engine 100. The coolant may be any engine coolant known to a person of ordinary skill in the art, for example, oil. Hereinafter, the cooling channels transporting oil in the system will be referred to as oil channels.

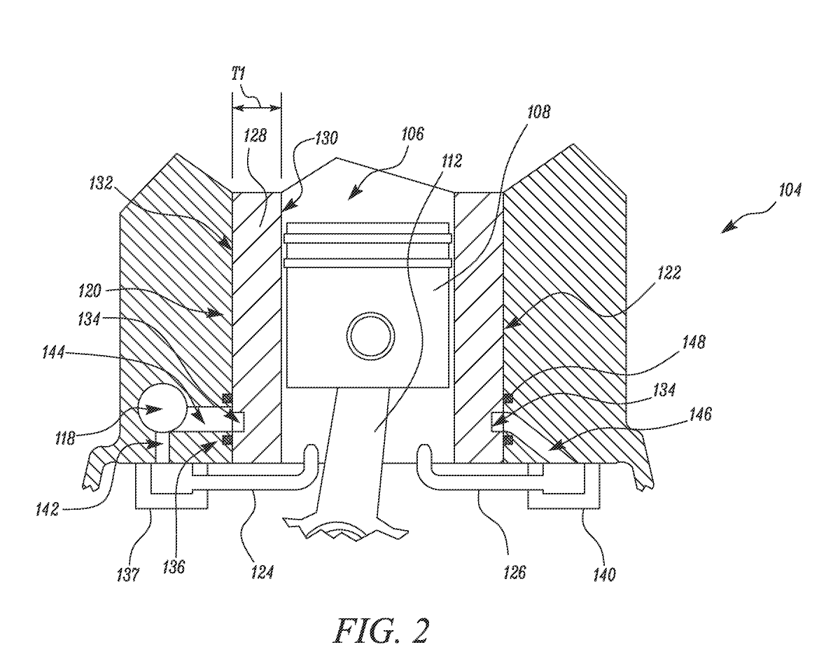

FIG. 2 illustrates a cross-sectional view of a portion of the engine block 104 of FIG. 1. An oil channel 118 is associated with a given piston 108 of the engine 100. Although only a single piston 108 is depicted in the accompanying figures, the system may include a number of such pistons 108. Further, as discussed earlier, the configuration of the engine 100 is not limited to that of the inline engine and can be utilized in connection with the V-type engine without any limitation. The oil channel 118, hereinafter interchangeably referred to as oil channel 118, is provided within the engine block 104. The location of the oil channel 118 with respect to the piston 108 may vary. For example, the oil channel 118 may be provided either on a first side 120 or a second side 122 of the piston 108. The first and second sides 120, 122 of the piston 108 described herein are positioned on diametrically opposing locations with respect to the piston 108. It may also be possible to have the oil channel 118 at the first side 120 and the second side 122 of the piston 108, or to have the oil channel 118 at the front part of the engine 100 and an additional oil channel 118 at the rear part of the engine 100.

In the illustrated embodiment, the oil channel 118 is provided on the first side 120 of the piston 108, such that the oil channel 118 is positioned near a bottom of the piston 108. In a situation wherein the engine 100 is the V-type engine, the oil channel 118 may be provided at a center of the V-type engine. Dimensions of the oil channel 118 may vary based on the application. The oil channel 118 is provided within the engine block 104 using known methods, for example, milling, casting and so on.

At least two oil nozzles are positioned at a base of the piston 108. The oil nozzles are configured to spray the oil on the piston 108. In the illustrated embodiment, the cooling system includes a first oil nozzle 124 and a second oil nozzle 126. The first and second oil nozzles 124, 126 are provided at the first and second sides 120, 122 of the piston 108 respectively. The first and second oil nozzles 124, 126 are positioned such that the oil may be sprayed onto the bottom of the piston 108 or in an oil gallery of the piston 108 from below of the piston 108. It should be noted that the number of oil nozzles may vary based on the size and power of the engine 100. For example, in a high power engine four oil nozzles may be provided in association with the piston 108.

Further, a cylinder liner 128, hereinafter referred to as liner 128 is provided within each of the cylinders 106. More particularly, the liner 128 is provided between a bore of the cylinder 106 and the piston 108. The liner 128 is provided as a replaceable sleeve in order to reduce or avoid wear of an inner wall of the respective cylinder 106. The liner 128 of the engine 100 includes an inner surface 130 and an outer surface 132. The inner and outer surfaces 130, 132 of the liner 128 define a thickness T1 of the liner 128 therebetween.

The outer surface 132 of the liner 128 includes a circumferential channel provided thereon. The circumferential channel is embodied as a groove 134. In the illustrated embodiment, the liner 128 includes a single groove 134. Alternatively, the liner 128 may include a set of grooves 134 provided in a helical pattern on the outer surface 132 of the liner 128. Further, the groove 134 is provided at a lower part 136 of the liner 128 such that the groove 134 is proximate to the oil channel 118. Further, a depth of the groove 134 is lesser than the thickness T1 of the liner 128, such that the groove 134 does not completely cut through a surface of the liner 128. In the illustrated embodiment, the depth of the groove 134 is approximately 20-30% of the thickness T1 of the liner 128. Alternatively, the depth may be approximately 50% of the thickness T1 of the liner 128.

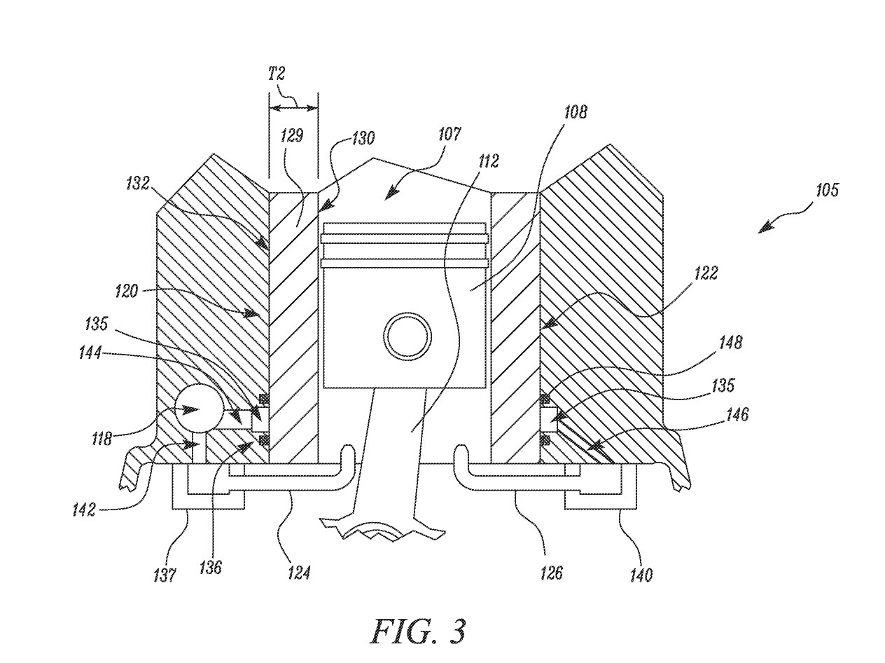

FIG. 3 illustrates an alternate embodiment of the present disclosure. In this embodiment, a thickness T2 of the liner 129 is less than the thickness T1 of the liner 128, explained in relation to FIG. 2. Accordingly, the liner 129 may not be able to accommodate the depth of the groove 135 therein. The groove 135 is therefore provided within the engine block 105. More particularly, the groove 135 is provided circumferentially about the cylinder 107. More particularly, the groove 135 is provided in communication with the inner wall of the cylinder 107.

Referring now to FIGS. 2 and 3, the groove 134, 135 is configured to fluidly connect the first and second oil nozzles 124, 126 and the oil channel 118. The first and second oil nozzles 124, 126 include a coolant collection chamber 138, 140 respectively. The coolant collection chamber 138, 140 may be configured to hold the oil received from the oil channel 118. A passage 142 is provided within the engine block 104, 105 to fluidly connect the oil channel 118 with the first oil nozzle 124 and the groove 134, 135 respectively at the first side 120. Another passage 144 provided on the first side 120 of the piston 108 fluidly connects the oil channel 118 to the groove 134, 135. Further, a passage 146 is provided on the second side 122 of the piston 108 to fluidly connect the groove 134, 135 with the second oil nozzle 126. These passages 142, 144, 146 may be milled within the engine block 104, 105. Thus, a continuous passage for the oil is provided connecting the oil channel 118, the first oil nozzle 124, the groove 134, 135 and the second oil nozzle 126 respectively.

The liner 128, 129 also includes a sealing member 148 provided in contact with the outer surface 132 of the liner 128, 129 and the inner wall of the cylinder 106, 107. The sealing member 148 is disposed surrounding the groove 134, 135 of the liner 128, 129 that is the sealing member 148 is provided at an upper edge and a lower edge of the groove 134, 135. In the illustrated embodiment, the sealing member 148 is disposed in the engine block 104, 105.

Alternatively, the sealing member 148 may be disposed in the liner 128, 129. The sealing member 148 is configured to reduce or control leakage of the oil flowing through the groove 134, 135 of the liner 128, 129. In one example, the sealing member 148 is an O-ring made of a rubber.

### Industrial Applicability

High power, high performance engines generally require at least two oil nozzles to cool the piston provided within the engine block. Each of the oil nozzles is configured to spray the coolant on the piston in order to prevent an over-heating of the piston. Further, the oil nozzles also provide lubrication to a lower part of the cylinder, thereby preventing a fretting of the cylinder. The engine block includes the oil channels provided therewithin. The oil channels are configured to supply the oil to the oil nozzles. For example, two oil channels are associated with the oil nozzles for the inline engine and three oil channels for the V-type engine respectively.

The present disclosure relates to providing the single oil channel 118 associated with each of the cylinders 106, 107 of the engine block 104, 105. Including the single oil channel 118 with respect to the piston 108 is a simpler design that is cost effective. The engine block 104, 105 disclosed herein includes the groove 134, 135 disposed about and provided in communication with the liner 128, 129 and the cylinder 106, 107. The groove 134, 135 is configured to fluidly connect the oil channels 118 and the first and second oil nozzles 124, 126.

During operation, the oil channel 118 is configured to receive the oil therewithin. The oil from the oil channel 118 flows through the passage 142 into the coolant collection chamber 138 provided at the first side 120 of the piston 108. The coolant collection chamber 138 is configured to deliver oil to the first oil nozzle 124. Accordingly, the oil received by the first oil nozzle 124 is sprayed onto the bottom of the piston 108 or in the oil gallery of the piston 108.

Further, the oil from the oil channel 118 is also configured to flow through the passage 144 and into the groove 134, 135. The oil flows through the groove 134, 135 and the passage 146 into the coolant collection chamber 140 provided on the second side 122 of the piston 108. Further, the second oil nozzle 126 is configured to spray the oil received from the oil channel 118, the passage 144, the groove 134, 135 and the passage 146 onto the bottom of the piston 108 or in the oil gallery of the piston 108.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

1. An engine block, comprising:
a cylinder;
a piston slidably received within the cylinder;
a liner positioned between the cylinder and the piston;
a groove disposed circumferentially about and provided the liner, the groove being in communication with the liner and the cylinder;
at least two oil nozzles arranged spaced apart from each other, the oil nozzles configured to spray oil on the piston; and
an oil channel configured to supply oil to at least one of the two oil nozzles via the groove.

2. The engine block of claim 1, wherein one of the oil nozzles is provided on a first side of the piston and another of the oil nozzles is provided on a second side of the piston such that the first and second sides oppose each other.

3. The engine block of claim 2, wherein the oil channel is located on any one of the first and second sides of the piston.

4. The engine block of claim 1 further comprising:
a sealing member disposed adjacent the groove.

5. The engine block of claim 1, wherein the groove is in fluid communication with the oil nozzles.

6. The engine block of claim 1, wherein the groove is a first groove and the engine block includes a second groove.

7. The engine block of claim 1, wherein the groove is provided on the liner.

8. The engine block of claim 7, wherein the groove is located at a lower part of the liner.

9. The engine block of claim 7, wherein a depth of the groove is lesser than a thickness (T1, T2) of the liner.

10. The engine block of claim 1, wherein the groove is provided in communication with an inner wall of the cylinder.

11. An engine, comprising:
a cylinder;
a piston slidably received within the cylinder;
a liner positioned between the cylinder and the piston;
a groove disposed circumferentially about the liner, the groove being in communication with the liner and the cylinder;
at least two oil nozzles arranged spaced apart from each other, the oil nozzles configured to spray oil on the piston;
an oil channel configured to supply oil to at least one of the two oil nozzles via the groove;
a connecting rod extending from a first end coupled to the piston to a second end; and
a crankshaft coupled to the second end.

12. The engine of claim 11, further including a plurality of cylinders disposed in a V-type configuration.

13. The engine block of claim 12, wherein the oil channel is positioned at a center of the V-type configuration.

14. A cylinder liner comprising:
an inner surface,
an outer surface, and
a circumferential channel with at least an opening at the outer surface to transport oil.

15. The cylinder liner of claim 14, wherein the channel is a groove on the outer surface.

16. The cylinder liner of claim 14, wherein
the cylinder liner has an upper part and a lower part,
the upper part is directed in an operational state to the cylinder head, and
the circumferential groove is disposed adjacent the lower part.

17. The cylinder liner of claim 15, wherein a depth of the groove is lesser than a thickness (T1, T2) of the liner.

18. The engine block of claim 4, wherein the sealing member is a first sealing member disposed on one side of the groove and the engine block includes a second sealing member disposed on an opposite side of the groove.

19. The engine block of claim 4, wherein the first groove is provided on the liner and the second groove is provided on the cylinder.

20. The engine of claim 11, further including a plurality of cylinders disposed in an inline configuration.
